(19) United States
(12) Patent Application Publication
(10) Pub. No.: US 2023/0063700 A1
(43) Pub. Date: Mar. 2, 2023

(54) RESIN MOLDED ARTICLE

(71) Applicant: NIHON PLAST CO., LTD., Fujinomiya-shi (JP)

(72) Inventors: Fumihiko Kimura, Shizuoka (JP); Kouji Sugiyama, Shizuoka (JP); Tomoyuki Nakano, Shizuoka (JP); Kenichi Kamio, Shizuoka (JP)

(21) Appl. No.: 17/847,218

(22) Filed: Jun. 23, 2022

(30) Foreign Application Priority Data
Aug. 30, 2021 (JP) 2021-139909

(51) Int. Cl. B62D 25/16

(52) U.S. Cl. CPC B62D 25/161; B60R 13/0861

(57) ABSTRACT

A resin molded article capable of improving a bonding strength between a first member and a second member is provided. Resin molded article includes first member and second member that is made of a resin, in which the first member and the second member are integrally molded. Resin molded article includes extension section that is formed by second member and that is positioned outward with respect to at least a part of outer edge section of first member. Resin molded article includes gate section that is disposed on extension section and that is a section into which a molten resin raw material flows during molding. First member has area expansion section at outer edge section in contact with extension section and along a direction where the molten resin raw material flows from gate section.

### CROSS REFERENCE TO RELATED APPLICATIONS

The disclosure of Japanese Patent Application No. 2021-139909 filed on Aug. 30, 2021 including the specification, drawings and abstract is incorporated herein by reference in its entirety.

### TECHNICAL FIELD

The present invention relates to a resin molded article in which a first member and a second member are integrally molded.

### BACKGROUND ART

In recent years, from the viewpoint of a silent property in the interior of an automobile, a resin molded article in which a non-woven fabric material is used may be used. For example, as a fender protector attached to the inside of a wheel house of a vehicle body of an automobile, it is known that a sound-absorbing non-woven fabric is integrally molded with a synthetic resin to suppress the propagation of noise generated during traveling of the vehicle to the vehicle interior (see, for example, Patent Literature 1).

In such a composite material of a non-woven fabric and a synthetic resin, it is desired to ensure the bonding strength between the non-woven fabric and the synthetic resin. In this respect, it is known that a bonding section between the non-woven fabric and the synthetic resin is formed in an uneven shape (see, for example, Patent Literature 2).

### CITATION LIST

### Patent Literature

PTL 1

Japanese Patent Application Laid-Open No. 2015-13538 (pages 4 to 9 and FIGS. 1 to 5)

PTL 2

International Publication No. WO2009/034906 (pages 7 to 17 and FIG. 1)

### SUMMARY OF INVENTION

### Technical Problem

In a case where the synthetic resin is integrally molded with the non-woven fabric, a bonding strength between the non-woven fabric and the synthetic resin differs depending on the relationship between an edge section of the non-woven fabric and a flow direction of a molten resin raw material during the molding of the synthetic resin. As a result, the bonding strength between the non-woven fabric and the synthetic resin tends to be uneven.

The present invention has been made in view of such a point, and an object of the present invention is to provide a resin molded article capable of improving the bonding strength between a first member and a second member.

### Solution to Problem

A resin molded article claimed in claim 1 includes a first member and a second member that is made of a resin, the first member and the second member being integrally molded, in which the resin molded article includes an extension section that is formed by the second member and that is positioned outward with respect to at least a part of an outer edge section of the first member, and a gate section that is disposed on the extension section and that is a section into which a molten resin raw material flows during molding, and the first member has an area expansion section at the outer edge section in contact with the extension section and along a direction where the molten resin raw material flows from the gate section.

In the resin molded article according to claim 1, the resin molded article claimed in claim 2, in which the area expansion section is a recessed section extending in a direction intersecting with the direction where the molten resin raw material flows from the gate section, is provided.

In the resin molded article according to claim 1 or 2, the resin molded article claimed in claim 3, in which the first member is set so that a surface area of the outer edge section increases as a distance from the gate section increases due to the area expansion section, is provided.

### Advantageous Effects of Invention

According to the resin molded article claimed in claim 1, the bonding strength between the first member and the second member can be improved by the area expansion section set according to the direction where the molten resin raw material flows.

According to the resin molded article claimed in claim 2, in addition to the effect of the resin molded article according to claim 1, the bonding strength between the first member and the second member can be further improved.

According to the resin molded article claimed in claim 3, in addition to the effect of the resin molded article according to claim 1 or 2, the bonding strength between the first member and the second member is made uniform for each position of the outer edge section, and unevenness of the bonding strength can be suppressed.

### BRIEF DESCRIPTION OF DRAWINGS

FIG. 1 is an enlarged plan view showing a part of a resin molded article according to an embodiment of the present invention;

FIG. 2 is a perspective view of the same resin molded article;

FIGS. 3(a) to 3(j) are explanatory diagrams showing examples of an area expansion section of the same resin molded article as shown in FIGS. 3(a) to 3(j);

FIGS. 4(a) to 4(d) are explanatory diagrams in which FIG. 4(a) is an explanatory diagram showing a first example of the present invention, FIG. 4(b) is an explanatory diagram showing a first comparative example, FIG. 4(c) is an explanatory diagram showing a second example, and FIG. 4(d) is an explanatory diagram showing a second comparative example; and

FIG. 5 is a table showing examples of feature data and test results of FIGS. 4(a) to 4(d).

### DESCRIPTION OF EMBODIMENTS

Hereinafter, an embodiment of the present invention will be described with reference to the drawings.

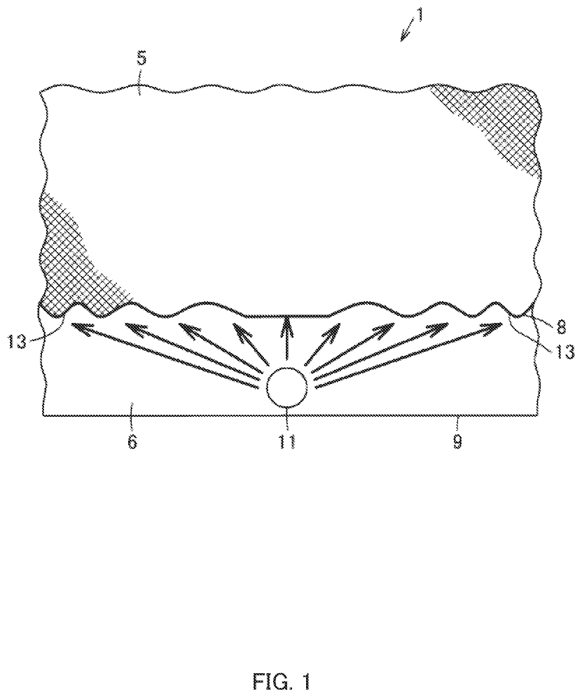

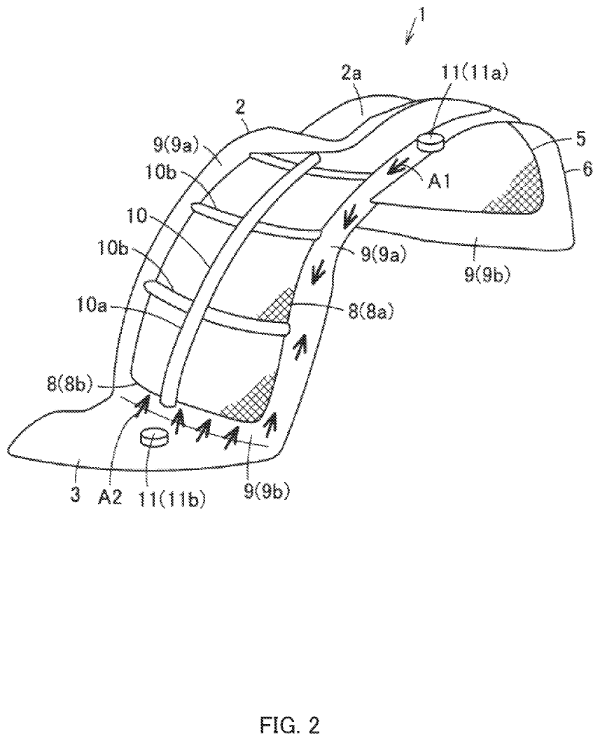

In FIGS. 1 and 2, 1 is a resin molded article. Resin molded article 1 is a resin molded article for a vehicle, which is used for a vehicle such as an automobile, for example. In the present embodiment, as resin molded article 1, a fender protector (fender liner), which is a protective member, will be described as an example. That is, resin molded article 1 of the present embodiment is an exterior material for a vehicle, is attached to a fender panel inside a wheel house of a vehicle such as an automobile, for example, to cover the upper side of tires and the like, and protects other parts of a vehicle body from mud and pebbles splashed by the tires. Resin molded article 1 has main body section 2 serving as an insert section. In the present embodiment, main body section 2 is generally formed in an arc shape along a curve of a tire or an arch-curved surface shape. Main body section 2 is formed with notch section 2a on one side of the upper part. A vehicle member such as a section for holding a tire or a suspension apparatus is disposed in notch section 2a.

Hereinafter, the vertical direction, the horizontal direction, and the front-rear direction will be described with reference to the forward direction in a case where a vehicle goes straight with resin molded article 1 attached to a vehicle body side.

Attachment section 3 serving as a resin section is integrally formed at an end section of main body section 2. Attachment section 3 is used to attach resin molded article 1 on the vehicle body side. In the present embodiment, attachment section 3 extends forward from a front end section of resin molded article 1.

Resin molded article 1 is configured by integrally molding first member 5 and second member 6. In the present embodiment, main body section 2 is formed with first member 5 and second member 6, and second member 6 constitutes attachment section 3.

In the present embodiment, first member 5 is a porous member having air permeability. First member 5 is formed in a sheet shape or a plate shape. First member 5 has a sound absorbing property, and is configured to absorb collision sound such as chipping sound and splash sound caused by collisions of earthy materials, pebbles, water, and the like, scratch noise such as pattern noise and road noise caused by the sliding contact between a road surface and tires, and the like. First member 5 is mainly disposed on main body section 2 to spread out in a planar shape. That is, in the present embodiment, first member 5 has a planar shape that curves along the curved shape of resin molded article 1. In addition, first member 5 is formed to be longitudinal in a direction where first member 5 curves. First member 5 constitutes a sound insulating section for chipping sound on the rear side of main body section 2 of resin molded article 1, and constitutes a sound insulating section for the inside of an engine room at the upper part. In addition, first member 5 is disposed on a part of a product surface of main body section 2 of resin molded article 1. A material for forming first member 5 is, for example, a hard non-woven fabric.

Second member 6 is a synthetic resin member formed of a thermoplastic synthetic resin. Second member 6 has rigidity.

Second member 6 is positioned to be adhered to or partially impregnated with outer edge section 8 of first member 5. That is, second member 6 constitutes extension section 9 extending outward from at least a part of outer edge section 8 of first member 5. Extension section 9 is formed with a width equal to or larger than a predetermined width with respect to outer edge section 8 of first member 5. In outer edge section 8 of first member 5, extension section 9 includes first extension sections 9a positioned along long side sections 8a that are first side sections, and second extension sections 9b positioned along short side sections 8b that are second side sections.

First extension sections 9a form a left side section and a right side section of main body section 2 and each first extension section has a curved shape. That is, at least a part of extension section 9 constitutes main body section 2 integrally with first member 5. First extension sections 9a are disposed to extend longitudinally in the front-rear direction along both long side sections 8a of outer edge section 8 of first member 5.

Second extension sections 9b overlap with attachment section 3. Second extension sections 9b extend between end sections of both first extension sections 9a, and are disposed along both short side sections 8b of outer edge section 8 of first member 5 in the left-right direction. That is, second extension sections 9b extend in a direction intersecting with first extension sections 9a. Second extension sections 9b are formed shorter than first extension sections 9a.

Furthermore, in the present embodiment, second member 6 constitutes reinforcing bead 10 that covers a part of first member 5. Reinforcing bead 10 is a section for ensuring the fluidity of a molten resin raw material for molding second member 6 and the rigidity of resin molded article 1. Reinforcing bead 10 is positioned in main body section 2. Reinforcing bead 10 is formed in an elongated linear shape. In the shown example, reinforcing bead 10 includes first bead section 10a disposed between first extension sections 9a and 9a and second bead sections 10b through which first extension sections 9a and 9a are connected, and has a grid shape. First bead section 10a is positioned in the middle section between first extension sections 9a and 9a, and is formed in an elongated rod shape along the curvature of resin molded article 1 in the front-rear direction. Second bead sections 10b connect first extension sections 9a and 9a and each second bead section 10b is formed in an elongated rod shape extending in the left-right direction.

Second member 6 is integrally molded with first member 5 by solidification of the molten resin raw material that is injection-molded from a gate of a cavity that is an interior space section of a molding die. Therefore, resin molded article 1 is formed with gate section 11 corresponding to the gate of the molding die. That is, gate section 11 is a gate mark of the molding die. Gate section 11 is set on extension section 9. In the present embodiment, gate section 11 includes first gate section 11a set on one first extension section 9a and second gate section 11b set on one second extension section 9b.

First gate section 11a is positioned to face one long side section 8a of outer edge section 8 of first member 5. First gate section 11a is disposed at one first extension section 9a at the upper end section of main body section 2.

Second gate section 11b is positioned to face one short side section 8b of outer edge section 8 of first member 5. Second gate section 11b is disposed at the front end section of main body section 2, that is, at second extension section 9b of attachment section 3 in the present embodiment.

Then, in outer edge section 8 of first member 5 in contact with extension section 9 on which gate section 11 is disposed, area expansion section 13 is set at a portion along the longitudinal direction of the molten resin raw material from gate section 11. For example, in outer edge section 8, area expansion section 13 is set on at least one long side section 8a. Regarding outer edge section 8, area expansion section 13 may be set on each long side section 8a and each short side section 8b.

Area expansion section 13 improves a bonding strength (tensile strength) of first member 5 to second member 6 by increasing a surface area per unit length of first member 5 in outer edge section 8.

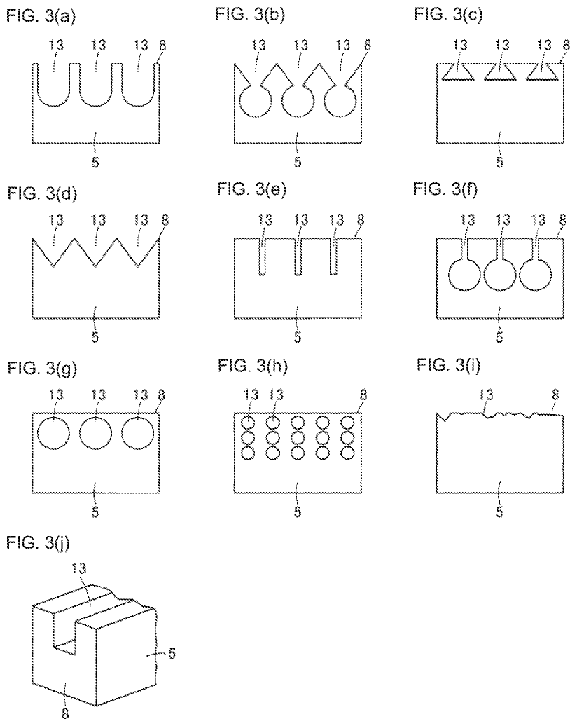

A shape of area expansion section 13 may be arbitrarily set. However, area expansion section 13 may be a recessed section cut out in a U shape as shown in FIG. 3(a), may be a recessed section shaped in a triangle that gradually narrows toward the inside of first member 5 from the outer edge section 8 side with a circular tip end as shown in FIG. 3(b), may be a triangle-shaped recessed section that is gradually widened toward the inside of first member 5 from the outer edge section 8 side as shown in FIG. 3(c), may be a triangle shape that gradually narrows toward the inside of first member 5 from the outer edge section 8 side as shown in FIG. 3(d), may be a slit shape that extends inward from outer edge section 8 as shown in FIG. 3(e), or may be a recessed section shaped in a slit with a circular tip end as shown in FIG. 3(f), for example.

Furthermore, area expansion section 13 is not limited to a shape that is opened to outer edge section 8 for outward communication as examples shown in FIGS. 3(a) to 3(f). Area expansion section 13 may have a shape in which the inside of outer edge section 8 is punched out in a circular shape as shown in FIG. 3(g), or may be formed with a large number of circular pin holes as shown in FIG. 3(h). In these cases, a molten synthetic resin can enter area expansion section 13 by its injection/impregnation pressure.

Area expansion section 13 is not limited to the shapes obtained by processing outer edge section 8, and as shown in FIG. 3(i), outer edge section 8 may have irregular unevenness in a case where first member 5 is cut.

Furthermore, such a shape of area expansion section 13 may be formed in a surface direction of first member 5, or may be formed in a thickness direction of first member 5 as shown in FIG. 3(j).

Area expansion section 13 is not limited to only one shape, and may be used by, for example, combining any of FIGS. 3(a) to 3(j), as necessary.

As shown in FIG. 1, area expansion section 13 is set so that a surface area of outer edge section 8 increases as a distance from gate section 11 increases. That is, area expansion section 13 is formed so that an arrangement pitch becomes smaller or an area of the unevenness or the opening becomes larger as the distance from gate section 11 increases.

Preferably, area expansion section 13 is formed to extend in a direction intersecting with, more preferably orthogonal to, the direction where the molten resin raw material flows from gate section 11. In the present embodiment, it is preferable that area expansion section 13 is formed on long side section 8a of outer edge section 8 of first member 5, which faces first gate section 11a, to extend in the left-right direction.

In a case where resin molded article 1 is produced, first member 5 cut into a predetermined shape in advance is set and held in the molding die. Thereafter, the molding die is closed, the molten resin raw material is injected from the gate to the cavity in the molding die, and the cavity is filled with the molten resin raw material.

At this time, the molten resin raw material injected from the gate of the molding die constituting gate section 11 toward outer edge section 8 of first member 5 flows out radially from the cavity and then flows along outer edge section 8. Therefore, as shown by the plurality of arrows in FIG. 1, an incident angle of the molten resin raw material on outer edge section 8 approaches an acute angle (direction parallel to outer edge section 8) as the distance from gate section 11 increases.

For example, the molten resin raw material injected from a gate serving as first gate section 11a flows out radially from the cavity and then flows mainly to spread in the front-rear direction that is the longitudinal direction of first member 5. That is, the molten resin raw material injected from a gate serving as first gate section 11a of gate section 11 flows in a direction parallel to long side section 8a of outer edge section 8 of first member 5 as shown by the arrow A1 in FIG. 2, as a position becomes farther from first gate section 11a in the front-rear direction.

On the other hand, the molten resin raw material injected from a gate serving as second gate section 11b flows out radially from the cavity and then flows mainly to spread in the lateral direction of first member 5. That is, the molten resin raw material injected from the gate serving as second gate section 11b of gate section 11 flows as shown by the arrow A2 in FIG. 2 from second gate section 11b, and flows in a direction parallel to long side section 8a of outer edge section 8 of first member 5 at a position along long side section 8a.

Therefore, the molten resin raw material enters area expansion section 13 formed at the position along long side section 8a of outer edge section 8 of first member 5, so that a contact area between the molten resin raw material and first member 5 is secured. As a result, the bonding strength (tensile strength) between second member 6 and first member 5, which are formed by solidification of the molten resin raw material with cooling, is made uniform in each part, and resin molded article 1 in which first member 5 and second member 6 are firmly integrated is molded.

Resin molded article 1 that has been molded is demolded, burrs and the like are then removed, and as necessary, surface treatment decoration, or the like is carried out to complete resin molded article 1.

As described above, according to one embodiment, outer edge section 8 of first member 5 has area expansion section 13 at a position in contact with extension section 9 and along the direction where the molten resin raw material flows from gate section 11. As a result, the bonding strength between first member 5 and second member 6 can be improved by area expansion section 13 set according to the direction where the molten resin raw material flows.

Since area expansion section 13 is the recessed section that extends in the direction intersecting the direction where the molten resin raw material flows from gate section 11, the bonding strength between first member 5 and second member 6 can be further improved.

In addition, as shown in FIG. 3(b), FIG. 3(c), or FIG. 3(f), for example, area expansion section 13 is formed in the shape having a portion of a relatively larger area than the outside of first member 5 on at least a part of the inside of first member 5. Therefore, an increase in the anchor effect can be expected in the bonding between first member 5 and second member 6. In the case of the slit-shaped area expansion section 13 shown in FIG. 3(e), an increase in the anchor effect can be expected in the bonding between first member 5 and second member 6 by inclining an angle of the slit-shaped area expansion section 13 to an angle opposite to the direction where the molten resin raw material flows.

Furthermore, since the surface area of outer edge section 8 of first member 5 increases as the distance from gate section 11 increases due to area expansion section 13, the contact length between first member 5 and second member 6 (molten resin raw material) can be increased as the position becomes far from gate section 11 and close to parallel to the direction where the molten resin raw material flows. Therefore, it is possible to equalize the bonding strength between first member 5 and second member 6 at each position of outer edge section 8, suppress the formation of a weak section having a weak bonding strength locally, and suppress the unevenness of the bonding strength.

Since first member 5 that is an air permeable non-woven fabric and second member 6 that is made of a resin having rigidity are integrally molded, it is possible to provide resin molded article 1 with both a sound absorbing property and rigidity.

In one embodiment, resin molded article 1 can be applied to various vehicle exterior materials that are required to have soundproofing properties, such as an undercover of a vehicle exterior material.

Resin molded article 1 can be used as any exterior material in addition to the vehicle exterior material.

### EXAMPLES

Examples and comparative examples of the present invention will be described.

In examples and comparative examples, a tensile strength was measured by changing a relationship between the direction where the molten resin raw material flowed to first member 5 and the direction of area expansion section 13.

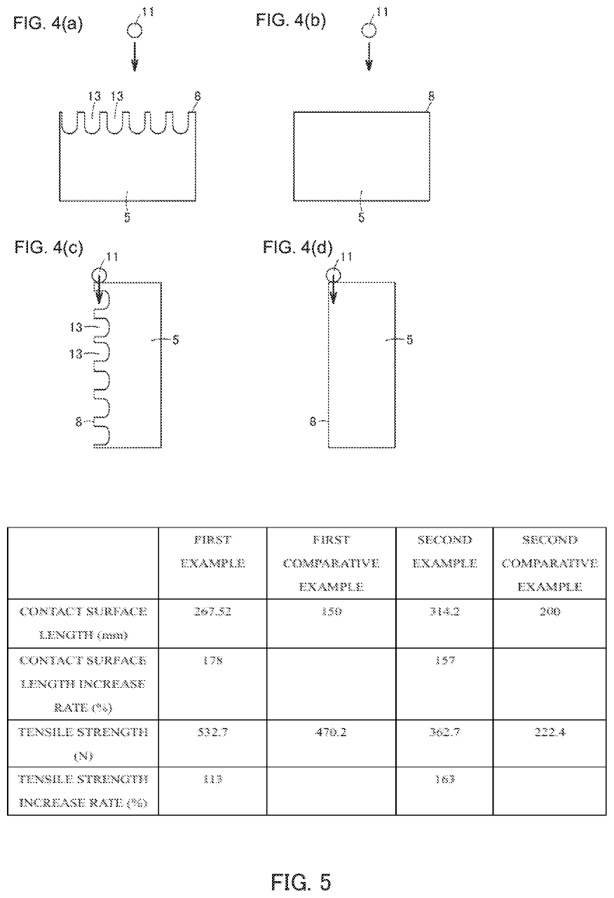

In each of a first example shown in FIG. 4(a) and a first comparative example shown in FIG. 4(b), a case where the molten resin raw material flows from gate section 11 in a direction perpendicular to outer edge section 8 of first member 5 is shown. That is, in the first example and the first comparative example, outer edge section 8 extends linearly in the direction orthogonal to the direction where the molten resin raw material flows indicated by the arrow in the figure, and in the first example, area expansion section 13 extends in the direction parallel to the direction where the molten resin raw material flows.

In each of a second example shown in FIG. 4(c) and a second comparative example shown in FIG. 4(d), a case where the molten resin raw material flows from gate section 11 in a direction parallel to outer edge section 8 of first member 5 is shown. That is, in the second example and the second comparative example, outer edge section 8 extends linearly in the direction parallel to the direction where the molten resin raw material flows indicated by the arrow in the figure, and in the second example, area expansion section 13 extends in the direction perpendicular to the longitudinal direction of the molten resin raw material.

Examples of these feature data and test results are shown in Table of FIG. 5.

As shown in Table of FIG. 5, in the first example and the first comparative example in which outer edge section 8 was perpendicular to the direction where the molten resin raw material flows, the tensile strength was greater than that of the second example and the second comparative example in which outer edge section 8 was parallel to the direction where the molten resin raw material flows.

In addition, the contact surface length and the tensile strength increased in each of the first example as compared with the first comparative example and the second example as compared with the second comparative example.

Furthermore, a tensile strength increase rate in the second example in which area expansion section 13 extends in the direction orthogonal to the direction where the molten resin raw material flows was large as compared with that of the first example in which area expansion section 13 extends in the direction parallel to the direction where the molten resin raw material flows.

As a result, it was individually shown that the tensile strength can be increased in the case where outer edge section 8 was along the direction intersecting with the direction where the molten resin raw material flows as compared with the case where outer edge section 8 was along the parallel direction; the tensile strength can be increased by area expansion section 13; and the tensile strength can be increased in the case where area expansion section 13 was formed in the direction intersecting with the direction where the molten resin raw material flows as compared with the case where area expansion section 13 was formed in the direction parallel to the direction where the molten resin raw material flows.

### INDUSTRIAL APPLICABILITY

The present invention can be suitably used as an exterior material for a vehicle, such as a fender protector and an undercover of an automobile.

### REFERENCE SIGNS LIST

1 Resin molded article

5 First member

6 Second member

8 Outer edge section

9 Extension section

11 Gate section

13 Area expansion section

What is claimed is:

1. A resin molded article comprising a first member, and a second member that is made of a resin, the first member and the second member being integrally molded,
wherein the resin molded article includes an extension section that is formed by the second member and that is positioned outward with respect to at least a part of an outer edge section of the first member, and
a gate section that is disposed on the extension section and that is a section into which a molten resin raw material flows during molding, and
the first member has an area expansion section at the outer edge section in contact with the extension section and along a direction where the molten resin raw material flows from the gate section.

2. The resin molded article according to claim 1,
wherein the area expansion section is a recessed section extending in a direction intersecting with the direction where the molten resin raw material flows from the gate section.

3. The resin molded article according to claim 1,
wherein the first member is set so that a surface area of the outer edge section increases as a distance from the gate section increases due to the area expansion section.
